(19) United States
(12) Patent Application Publication
(10) Pub. No.: US 2025/0293369 A1
(43) Pub. Date: Sep. 18, 2025

(54) BATTERY MODULE

(71) Applicant: SK On Co., Ltd., Seoul (KR)

(72) Inventors: Seon Gi MIN, Daejeon (KR); Yun Joo NOH, Daejeon (KR); Chul Jin BAE, Daejeon (KR); Gang U LEE, Daejeon (KR); Tae Gu LEE, Daejeon (KR)

(21) Appl. No.: 19/077,850

(22) Filed: Mar. 12, 2025

(30) Foreign Application Priority Data
Mar. 12, 2024 (KR) 10-2024-0034210

(51) Int. Cl. H01M 50/242; H01M 50/211; H01M 50/291; H01M 50/293

(52) U.S. Cl. CPC H01M 50/242; H01M 50/211; H01M 50/291; H01M 50/293

(57) ABSTRACT

Provided is a battery module including: a battery cell stack including a plurality of battery cells stacked in one direction; a case for accommodating the battery cell stack; and a buffer pad disposed between the battery cell stack and the case, and intended to fix the battery cell stack to the case, wherein the buffer pad includes foam having open pores formed on a surface, and a surface of the case that is in contact with the buffer pad has a 10-point surface roughness (Rz) value of 3 μm or less.

### CROSS-REFERENCE TO RELATED APPLICATIONS

This application claims priority under 35 U.S.C. § 119 to Korean Patent Application No. 10-2024-0034210, filed on Mar. 12 2024, in the Korean Intellectual Property Office, the disclosure of which is incorporated herein by reference in its entirety.

### TECHNICAL FIELD

The following disclosure relates to a battery module.

### BACKGROUND

A secondary battery may be charged and discharged, unlike a primary battery, and may thus be applied to various fields such as a digital camera, a mobile phone, a laptop computer, and a hybrid vehicle. An example of the secondary battery may be a nickel-cadmium battery, a nickel-metal hydride battery, a nickel-hydrogen battery, a lithium secondary battery, or the like.

Among these secondary batteries, much research has been conducted on a lithium secondary battery having high energy density and high discharge voltage, and recently, the lithium secondary battery has been manufactured as a flexible pouch-type battery cell and used by connecting a plurality of batteries to form a module.

Conventionally, each battery module may be covered using a case surrounding the entire exterior of a stack in which the battery cells are stacked. Therefore, manufacturing the battery module necessarily requires a process of coupling the battery cell stack to the case.

Conventionally, an adhesive tape or the like may be used to closely attach and bond the battery cell to the case. In this case, the adhesive tape may slip during an assembly process, the adhesive tape may not be bonded sufficiently, or a separate process may be required to attach the adhesive tape.

### SUMMARY

An embodiment of the present disclosure is directed to providing a battery module having a simplified assembly process and a shortened process time compared to a conventional process of closely attaching and bonding a battery cell to a case by using an adhesive tape. Another embodiment of the present disclosure is directed to providing a battery module requiring no separate adhesive tape by adjusting an adhesive strength between a case and a buffer pad disposed between a battery cell stack and the case based on surface roughness.

The battery module according to the present disclosure may be widely applied to a green technology field such as an electric vehicle, a battery charging station, a solar or wind power generation using a battery, or the like. In addition, the battery module according to the present disclosure may be used in an eco-friendly electric vehicle, a hybrid vehicle, or the like to prevent climate change by suppressing air pollution and greenhouse gas emissions.

In one general aspect, provided is a battery module including: a battery cell stack including a plurality of battery cells stacked in one direction; a case for accommodating the battery cell stack; and a buffer pad disposed between the battery cell stack and the case, and intended to fix the battery cell stack to the case, wherein the buffer pad includes foam having open pores formed on a surface, and a surface of the case that is in contact with the buffer pad has a 10-point surface roughness (Rz) value of 3 μm or less.

The case may include a first case including a lower plate disposed at the bottom of the battery cell stack and side plates extending from the lower plate and supporting both sides of the battery cell stack, a second case disposed on top of the battery cell stack and fastened and fixed to the side plates of the first case, and a pair of third cases disposed on both sides of the battery cell stack not supported by the side plates of the first case.

The buffer pad may be disposed between the battery cell stack and at least one selected from the first case and the third case.

The buffer pad may be disposed between the battery cell stack and the third case.

A surface of the first case or the third case that is in contact with the buffer pad may have a 10-point surface roughness (Rz) value of 3 μm or less.

The buffer pad may include polyurethane foam.

The polyurethane foam may be soft polyurethane foam.

The polyurethane foam may have a density of 0.3 g/cm³ or less, and a shore hardness of 80 or less according to the American Society for Testing and Materials (ASTM) Standard D2240.

The buffer pad may have an adhesive strength of 40 gf/in or more according to the American Society for Testing and Materials (ASTM) Standard D3330.

Roughing or finishing processing may be performed on the surface of the case, and the 10-point surface roughness (Rz) value may be adjusted to 3 μm or less, and for example, the surface of the case may be barrel-finished.

The buffer pad may include the foam having the open pores formed on a surface or foam having the open pores that is stacked on one surface or both surfaces of a substrate.

Other features and aspects will be apparent from the following detailed description, the drawings, and the claims.

### BRIEF DESCRIPTION OF THE DRAWINGS

FIG. 1 is a perspective view schematically showing a battery module according to an embodiment of the present disclosure.

FIG. 2 is an exploded perspective view of the battery module shown in FIG. 1.

### DETAILED DESCRIPTION OF EMBODIMENTS

Hereinafter, embodiments of the present disclosure are described in detail. However, these embodiments are provided only as examples, and the present disclosure is not limited to these specific embodiments provided as the examples.

In addition, unless otherwise defined, all technical and scientific terms may have the same meanings as those commonly understood by any one of those skilled in the art to which the present disclosure pertains. Terms used in the present disclosure are provided only to effectively describe a specific embodiment, and are not intended to limit the present disclosure.

In addition, a term of a single number as used in the specification and the appended claims is intended to include its plural number unless the context clearly indicates otherwise.

In addition, unless explicitly described to the contrary, “including” any components will be understood to imply the inclusion of other components rather than the exclusion of any other components.

In addition, unless otherwise specified, when one layer or member is referred to as being disposed “on” another layer or member, one layer or member and another layer or member may be in contact with each other, or a third layer or member may be interposed between one layer or member and another layer or member.

In addition, a term of degree, such as “approximately” or “substantially,” is used to indicate a stated numerical value or its approximation when manufacturing or material tolerances inherent therein are considered. Such a term is used to prevent unscrupulous infringers from unfairly exploiting the present disclosure in which exact or absolute figures are stated to facilitate understanding of the present disclosure.

In addition, a term “upper side”, “upper part”, “lower side”, “lower part”, “side surface”, or the like is described with reference to a direction shown in the drawings, and this term may be described differently when its corresponding target changes the direction.

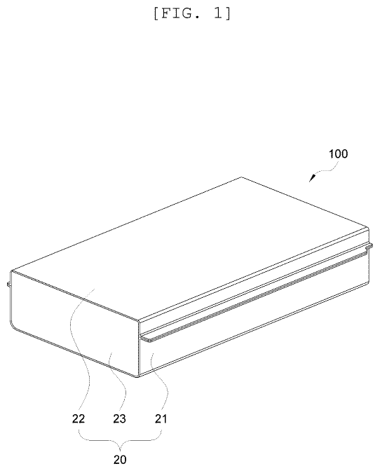

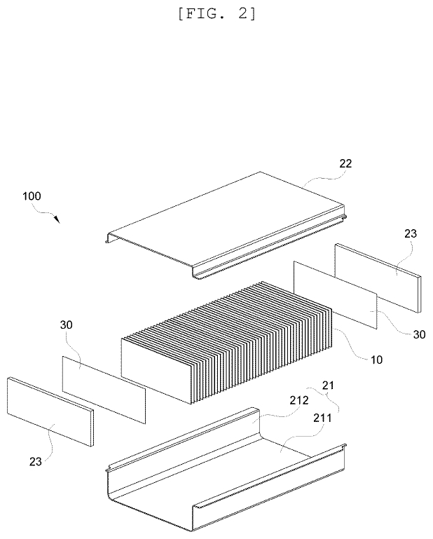

First, referring to FIGS. 1 and 2, a battery module 100 according to one aspect of the present disclosure may include a battery cell stack 10, a case 20, and a buffer pad 30.

For example, in one general aspect, provided is the battery module 100 including: a battery cell stack 10 including a plurality of battery cells stacked in one direction; a case 20 for accommodating the battery cell stack; and a buffer pad 30 disposed between the battery cell stack 10 and the case 20, and intended to fix the battery cell stack to the case, wherein the buffer pad 30 includes foam having open pores formed on a surface, and a surface of the case that is in contact with the buffer pad has a 10-point surface roughness (Rz) value of 3 μm or less.

The battery module according to one aspect of the present disclosure may adjust the surface roughness of the surface of the case that is in contact with the buffer pad, thereby bonding the battery cell stack 10 to the case 20 even without any separate adhesive tape or bonding member to prevent slipping, and allowing the buffer pad 30 to function as both a bonding and buffering component.

As a result of research to achieve an adhesive strength between the surface of the case and the buffer pad, inventors of the present disclosure confirmed that the surface roughness may be adjusted by surface processing the surface of the case that faces or is in direct contact with the buffer pad, such as roughing or finishing, for example, barrel finishing.

In addition, the inventors complete the present disclosure by confirming that the surface of the case exhibits excellent adhesion to the buffer pad including the foam in a range where the 10-point surface roughness (Rz) value of the case is 3 μm or less, 2.9 μm or less, 2.8 μm or less, 2.7 μm or less, 2.6 μm or less, 2.5 μm or less, 1 μm or more, 1.2 μm or more, 1.3 μm or more, 1.4 μm or more, 1.5 μm or more, 1.6 μm or more, 1.7 μm or more, 1.8 μm or more, 1.9 μm or more, 2 μm or more, or any value between these values.

A method for surface processing to achieve the 10-point surface roughness is not limited. For example, roughing or finishing processing, such as barrel finishing processing, may be performed, and is not limited thereto. It is confirmed that the adhesive strength is significantly reduced when the 10-point surface roughness (Rz) value exceeds 3 μm, and during a battery module assembly process, the adhesive strength between the surface of the case and the buffer pad may not be formed and slipping may thus occur.

In an embodiment, the case 20 may include a first case 21 including a lower plate 211 disposed at the bottom of the battery cell stack 10 and side plates 212 extending from the lower plate and supporting both sides of the battery cell stack, a second case 22 disposed on top of the battery cell stack and fastened and fixed to the side plates 212 of the first case 21, and a pair of third cases 23 disposed on both sides of the battery cell stack not supported by the side plates of the first case.

In one aspect, the surface of the case that is in contact with the buffer pad in the battery module according to the present disclosure may refer to surfaces of the pair of third cases 23 disposed on both the sides of the battery cell stack and a surface of the first case 21.

In one aspect, the surface of the case that is in contact with the buffer pad in the battery module according to the present disclosure may refer to the surface of the first case 21.

In one aspect, the surface of the case that is in contact with the buffer pad in the battery module according to the present disclosure may refer to the surfaces of the pair of third cases 23 disposed on both the sides of the battery cell stack.

For example, in one aspect, the pair of buffer pads 30 may be disposed between the pair of third cases 23 and the battery cell stack 10. Here, the surface of the third case 23 that is in contact with the buffer pad may have the 10-point surface roughness (Rz) value of 3 μm or less. In addition, the buffer pad 30 may include the foam having the open pores formed on its surface.

The buffer pad 30 may serve as a buffer member, may simultaneously serve to fix the battery cell stack 10 to the case 20, and may be attached to both the sides of the battery cell stack 10 or to an accommodation part of the battery cells exposed to both the sides of the battery cell stack 10.

The battery cell stack 10 may include a plurality of battery cells stacked in one direction. As an example, the battery cells may be stacked in a left-right direction (or horizontal direction). However, if necessary, the battery cells may also be stacked in a vertical direction.

Each of the battery cells may be a pouch-type secondary battery, and include an electrode lead externally protruding. The battery cell may be configured as an electrode assembly accommodated in a pouch.

The electrode assembly may include a plurality of electrode plates and electrode tabs and stored in the pouch. Here, the electrode plate may include a positive electrode plate and a negative electrode plate, and the electrode assembly may include the positive electrode plate and the negative electrode plate stacked so that their wide surfaces face each other while having a separator therebetween.

The positive electrode plate and the negative electrode plate may include an active material slurry applied to a current collector. Typically, the slurry may be formed by stirring a granular active material, a conductor, a binder, a plasticizer, or the like while a solvent is added thereto.

In addition, the electrode assembly may include the plurality of positive electrode plates and the plurality of negative electrode plates stacked in the vertical direction. Here, the plurality of positive electrode plates and the plurality of negative electrode plates may each include the electrode tab, and the same polarities may be in contact with each other to be connected to the same electrode lead.

The pouch may have a container shape to form the exterior of the battery cell and provide an internal space for accommodating the electrode assembly and an electrolyte (not shown). Here, the electrode leads of the electrode assembly may be partially exposed to the outside of the pouch.

The pouch may be classified into a sealing part and an accommodation part, may be joined using a heat-fusing method, and is not limited thereto.

The battery cell according to an embodiment may be a rechargeable and dischargeable battery, and specifically may be a lithium-ion (Li-ion) battery or a nickel metal hydride (Ni-MH) battery.

The battery cell or the battery cell stack 10 that includes the stacked plurality of battery cells may be stacked vertically in the case 20 described below in the left-right direction (or horizontal direction).

The buffer pad 30, which is the buffer member, may be attached to both the sides of the battery cell stack 10. The buffer pad 30 may be provided in the form of a pad or sheet, and may be attached to the accommodation part of the battery cells exposed to both the sides of the battery cell stack 10.

The buffer pad 30 may serve as the buffer member, may simultaneously serve to fix the battery cell stack 10 to the case 20, and may be compressed and elastically deformed when a specific battery cell 10 expands. Therefore, the buffer pad 30 may suppress the expansion of an entire volume of the battery cell stack. To this end, the buffer pad 30 may be made of a foam material such as polyurethane (PU) foam. The foam may have pores, and in particular, may be foam having the open pores formed on its surface, thus more effectively achieving the adhesion aimed at in the present disclosure.

In an embodiment, the polyurethane foam may be soft polyurethane foam, may have the open pores formed on its surface, and may be closely attached to the case surface processed to have the 10-point surface roughness (Rz) value of 3 μm or less to thus allow the open pores to be closely attached, compressed, and bonded to the corresponding surface.

In addition, in an embodiment, the polyurethane foam may have a density of 0.3 g/cm³ or less, 0.2 g/cm³ or less, 0.1 g/cm³ or more, or any value between these values, from a viewpoint of more effectively achieving the adhesion and buffer properties. For example, the buffer pad 30 may have a density of 0.1 to 0.3 g/cm³. In addition, the buffer pad 30 may have a shore hardness of 80 or less, 70 or less, 60 or more, or any value between these values according to the American Society for Testing and Materials (ASTM) Standard D2240. For example, the buffer pad 30 may have a shore hardness of 60 to 80. In addition, the buffer pad may satisfy an adhesive strength property of 40 gf/in or more, 41 gf/in or more, 42 gf/in or more, 43 gf/in or more, 44 gf/in or more, or 45 gf/in or more according to the American Society for Testing and Materials (ASTM) Standard D3330. In addition, the adhesive strength of the buffer pad does not have a limited upper limit and may be 65 gf/in or less, 63 gf/in or less, or any value between these values. For example, the buffer pad may have an adhesive strength of 40 to 65 gf/in. If the buffer pad satisfies the above density, shore hardness and adhesive strength range, the buffer pad may achieve a sufficient adhesive strength even without using any separate adhesive tape or bonding member. In addition, this configuration may shorten an assembly process time of the battery module and improve its process efficiency.

In detail, it may be confirmed that the buffer pad maintains the adhesion without slipping or separating from the case when the buffer pad is stacked on the case having the surface roughness (Rz) value adjusted to 3 μm or less, and then erected to a 90-degree angle to the left or right to evaluate a degree to which the buffer pad is bonded to the case (the degree of the buffer pad adhesion). If the surface roughness of the case exceeds 3 μm, the buffer pad may slip and separate from the case in a degree of buffer pad adhesion evaluation method even though the property of the buffer pad satisfies the above property range.

In an embodiment, the buffer pad may include the foam having the open pores formed on the surface, or foam having the open pores that is stacked on one surface or both surfaces of a substrate made of a material other than the foam, such as a polymer film or sheet.

In one aspect according to the present disclosure, the first case 21 and the second case 22 may be coupled to each other by welding or the like. However, the first case 21 and the second case 22 are not limited to this method, and may be coupled to each other in various modified ways, such as by sliding or by using a fixing member such as a bolt or a screw.

The first case 21 and the second case 22 may be disposed to face the upper and lower surfaces of the battery cell stack. The second case 22 may have the form of a flat plate, and be fastened to an upper end of the side plate 212 of the first case 21. Therefore, when the second case 22 is fastened to the first case 21, the second case 22 and the first case 21 may form the shape of a tubular member having an empty interior.

The first case 21 and the second case 22 may be made of a material having high thermal conductivity. For example, the first case 21 and the second case 22 may be made of metal, and more specifically, may be made of aluminum. However, the first case 21 or the second case 22 is not limited to this material, and may use various materials within the scope of the present disclosure as long as the corresponding material has high thermal conductivity.

In addition, although not shown separately in the drawings, at least one of the first case 21 and the second case 22 may be used as a heat dissipation member that releases heat occurring in the battery cell to the outside, and may further include a cooling device to increase cooling efficiency.

According to an embodiment, the cooling device may have a cooling path disposed therein. In detail, the cooling path may be a water-cooled cooling path or an air-cooled cooling path, and is not necessarily limited thereto.

The cooling device may be integrally coupled to the case 20 and included in the battery module. However, the present disclosure is not limited to this configuration, and, separately from the battery module, the cooling device may be included in a device or structure in which the battery module is mounted.

In an embodiment of the present disclosure, the pair of third cases 23 may be coupled to both the sides of the battery cell stack 10, where the electrode leads (not shown) of the battery cells are disposed, respectively. As shown in FIGS. 1 and 2, the pair of third cases 23 may be coupled to the first case 21 and the second case 22 to form an outer surface of the battery module 100 together with the first case 21 and the second case 22.

The pair of third cases 23 may be made of the material having high thermal conductivity. For example, the third case 23 may be made of metal, and more specifically, may be made of aluminum. However, the third case 23 is not limited to this material, and may use various materials within the scope of the present disclosure as long as the corresponding material has high thermal conductivity. In addition, the third case 23 may include a through hole (not shown) for exposing a connection terminal (not shown) of an insulating cover (not shown) to the outside.

The pair of third cases 23 may be coupled to the first case 21 and the second case 22 by using the fixing members such as the screws or bolts, and is not limited thereto.

The insulating cover (not shown) may be interposed between at least one side plate 212 and the battery cell stack 10. The insulating cover may be coupled to one surface of the battery cell stack 10, where the electrode leads of the battery cells are disposed. Therefore, the electrode leads may pass through the insulating cover and be interconnected on the outside of the insulating cover. To this end, the insulating cover may include a plurality of through holes into which the electrode leads are inserted.

In addition, the battery module according to the present disclosure may further include a component typically included in the battery module, and the description omits a detailed description thereof.

Hereinafter, Inventive Example of the present disclosure is further described with reference to specific experimental examples. Inventive Example and Comparative Example included in the experimental example are provided only to describe the present disclosure as examples and do not limit the scope of the appended claims, it is apparent to those skilled in the art that the embodiments may be variously altered and modified within the spirit and scope of the present disclosure, and these alternations and modifications also fall within the scope of the appended claims.

The following properties are evaluated as follows:

### 1. Buffer Pad Property Evaluation

The shore hardness of the buffer pad is measured according to ASTM D2240.

The adhesive strength of the buffer pad is measured according to a procedure of ASTM D3330. In detail, a sample is prepared by placing the buffer pad on a steel plate specimen prepared according to ASTM D3330. The sample is attached to a jig of a universal testing machine (UTM), and a force, at which the buffer pad is separated from the steel plate specimen at a peeling angle of 90 degrees, is measured. The unit is gf/in.

### 2. 10-Point Surface Roughness (Rz)

A 10-point surface roughness (Rz) value is measured according to ISO 4288 by using a surface roughness measuring instrument (178-570-11K SJ-310 S, Mitutoyo).

The surface roughness measuring instrument measures a surface roughness by scratching a product surface using a measuring needle disposed at the tip of a probe.

### 3.Degree of Adhesion Between Case and Buffer Pad

The degree of adhesion between the case and the buffer pad is evaluated as follows.

The buffer pads are stacked on the cases respectively prepared in Inventive Example and Comparative Example, and then erected at the angle of 90 degrees to the left or right to evaluate whether each buffer pad slides and separates from the case.
o: The buffer pad maintains adhesion without slipping and separating from the case.
x: The buffer pad slides and separates from the case.

### Inventive Example 1

Prepared is the buffer pad made of soft polyurethane foam material having a thickness of 3 mm, a density of 0.2 g/cm³, a shore hardness of 80 according to ASTM D2240, and an adhesive strength of 40 gf/in according to ASTM D3330.

The third case made of aluminum (ADC12) is prepared, and one surface of the third case is barrel-finished to adjust the 10-point surface roughness (Rz) to 3 μm.

The buffer pad is stacked on the barrel-finished surface of the third case, and then the degree of adhesion between the case and the buffer pad is evaluated, as shown in Table 1 below.

### Inventive Examples 2 and 3

The degree of adhesion is evaluated by performing the same as in Inventive Example 1, except that barrel finishing is performed in Inventive Example 1 to change the 10-point surface roughness (Rz) as shown in Table 1 below, and is shown in Table 1 below.

### Comparative Example 1

The degree of adhesion is evaluated by performing the same as in Inventive Example 1, except that barrel finishing is performed in Inventive Example 1 to change the 10-point surface roughness (Rz) as shown in Table 1 below, and is shown in Table 1 below.

TABLE 1

| | Inventive | Inventive | Inventive | Comparative |
|---|---|---|---|---|
| | Example 1 | Example 2 | Example 3 | Example 1 |
| Rz (μm) | 3 | 1.5 | 1.2 | 4 |
| Degree of adhesion | ∘ | ∘ | ∘ | x |
| between case and | | | | |
| buffer pad | | | | |

As shown in Table 1 above, it is confirmed that the buffer pad exhibits excellent adhesive strength property in Inventive Examples 1 to 3, in which the 10-point surface roughness is adjusted to 3 μm or less by barrel finishing. In addition, in Inventive Examples 1 to 3, the case and buffer pad are closely attached and bonded to each other in a state where the buffer pad are stacked on the barrel-finished surface of the third case, and accordingly, the case and buffer pad does not slip or separate from each other when both sides of the stack are held by hand and shaken. When the adhesive strength is achieved in this way, the battery assembly process may not require a bonding process using a separate adhesive tape, thereby simplifying the battery manufacturing process and reducing production costs.

In addition, as seen in Inventive Examples 2 and 3, the adhesive strength is increased as the 10-point surface roughness is decreased, and no significant difference is observed at the 10-point surface roughness of 1.2 μm or 1.5 μm.

However, as shown in Comparative Example 1, when the 10-point surface roughness is 4 μm, the degree of adhesion is significantly reduced, the buffer pad is not closely attached to and separates from the case, and the buffer pad separates from the case when both the sides of the stack are held by hand and shaken.

In one aspect according to the present disclosure, the battery module may exhibit the excellent adhesive strength by adjusting the adhesive strength between the buffer pad and the case without using any adhesive tape or bonding member.

In addition, the battery module may not require any adhesive tape, thereby further shortening its assembly process time.

The content described above is only an example of applying the principles of the present disclosure, and other configurations may be included within the scope of the present disclosure.

Hereinabove, the present disclosure has been described by the specific details and the limited embodiments, which have been provided only to assist in a comprehensive understanding of the present disclosure. Therefore, the present disclosure is not limited to these embodiments, and various modifications and changes may be made by those skilled in the art to which the present disclosure pertains based on this description.

Therefore, the spirit of the present disclosure should not be limited to these embodiments, and the appended claims and all modifications equal or equivalent to the claims are intended to fall within the scope and spirit of the present disclosure.

What is claimed is:

1. A battery module comprising:
a battery cell stack including a plurality of battery cells stacked in one direction;
a case for accommodating the battery cell stack; and
a buffer pad disposed between the battery cell stack and the case, and intended to fix the battery cell stack to the case,
wherein the buffer pad includes foam having open pores formed on a surface, and
a surface of the case that is in contact with the buffer pad has a 10-point surface roughness (Rz) value of 3 μm or less.

2. The battery module of claim 1, wherein the case includes
a first case including a lower plate disposed at the bottom of the battery cell stack and side plates extending from the lower plate and supporting both sides of the battery cell stack,
a second case disposed on top of the battery cell stack and fastened and fixed to the side plates of the first case, and
a pair of third cases disposed on both sides of the battery cell stack.

3. The battery module of claim 2, wherein the buffer pad is disposed between the battery cell stack and at least one selected from the first case and the third case.

4. The battery module of claim 3, wherein the buffer pad is disposed between the battery cell stack and the third case.

5. The battery module of claim 3, wherein a surface of the first case or the third case that is in contact with the buffer pad has a 10-point surface roughness (Rz) value of 3 μm or less.

6. The battery module of claim 1, wherein the buffer pad includes polyurethane foam.

7. The battery module of claim 6, wherein the polyurethane foam is soft polyurethane foam.

8. The battery module of claim 6, wherein the polyurethane foam has a density of 0.3 g/cm³ or less, and a shore hardness of 80 or less according to the American Society for Testing and Materials (ASTM) Standard D2240.

9. The battery module of claim 1, wherein the buffer pad has an adhesive strength of 40 gf/in or more according to the American Society for Testing and Materials (ASTM) Standard D3330.

10. The battery module of claim 1, wherein roughing or finishing processing is performed on the surface of the case, and
the 10-point surface roughness (Rz) value is adjusted to 3 μm or less.

11. The battery module of claim 1, wherein the surface of the case is barrel-finished, and
the 10-point surface roughness (Rz) value is adjusted to 3 μm or less.

12. The battery module of claim 1, wherein the buffer pad includes the foam having the open pores formed on a surface or foam having the open pores that is stacked on one surface or both surfaces of a substrate.
